(19) United States
(12) Patent Application Publication
(10) Pub. No.: US 2010/0101698 A1
(43) Pub. Date: Apr. 29, 2010

(54) METHOD FOR PRODUCING A STRUCTURAL ELEMENT

(75) Inventor: Erwin Bayer, Dachau (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/528,790

(22) PCT Filed: Feb. 20, 2008
(86) PCT No.: PCT/DE08/00303

§ 371 Date: Aug. 26, 2009

(30) Foreign Application Priority Data
Feb. 27, 2007 (DE) 10 2007 009 468.1

(51) Int. Cl. B32B 9/04

(52) U.S. Cl. 156/62.2

(57) ABSTRACT

A method for producing a structural element having a low density and high temperature resistance, where a plurality of hollow spheres made of a high temperature resistant material are connected together in a material fit, is disclosed. Adhesive bridges made of a high temperature resistant, inorganic adhesive are formed between the hollow spheres. The structural mass made of hollow spheres and adhesive is dried and cured at temperatures that are higher than the ambient temperature and are no higher than the subsequent utilization temperature of the structural element.

This application claims the priority of International Application No. PCT/DE2008/000303, filed Feb. 20, 2008, and German Patent Document No. 10 2007 009 468.1, filed Feb. 27, 2007, the disclosures of which are expressly incorporated by reference herein.

### BACKGROUND AND SUMMARY OF THE INVENTION

The invention relates to a method for producing a structural element having a low density and high temperature resistance.

These types of structural elements as well as methods for producing the same are known from the prior art.

Thus, German Patent Document No. DE 43 38 457 C2 describes a method for producing a component made of metal or ceramic with a dense, closed outer shell and a porous core, wherein the component is structured in a slip technique of solid whole particles of varying sizes as well as of hollow spheres of varying sizes and then dried and sintered.

German Patent Document No. DE 39 02 032 C2 protects a method for producing a sintered light-weight material in which metallic hollow spheres are densely stacked as well as connected by pre-sintering and the empty spaces between the hollow spheres are filled up with powdered metal, metal alloys or intermetallic compounds. The overall structure of hollow spheres and metallic powder is sintered into the desired light-weight material.

Exclusively high-temperature joining methods such as high-temperature soldering, welding, sintering, or sealing are used de facto to produce structural elements having a low density and high temperature resistance. The disadvantage of these methods among other things is that the material of the hollow spheres or of an adjacent substrate can be damaged. In addition, deviations in dimension and shape as well as cracks and fractures may be produced by shrinkage or structural deformation.

As compared with this, the objective of the invention is disclosing a method for producing a structural element having a low density and high temperature resistance, which reliably avoids the disadvantages cited.

The invention is to be viewed in that adhesion is used as the joining method, wherein a high temperature resistant, inorganic adhesive is used. Through the thermal drying and curing process, essentially only the adhesive is impacted and modified. The material of the hollow spheres or of an adjacent substrate remains geometrically and materially unchanged to the greatest possible extent. This results in substantially improved dimensional accuracy and structural homogeneity. The mechanical, thermal and chemical properties of the structural element are able to be improved as a result.

### BRIEF DESCRIPTION OF THE DRAWINGS

The invention will be explained in greater detail in the following on the basis of drawings. The following figures show simplified representations that are not to scale:

FIG. 1 is a partial section through a structural mass of hollow spheres and adhesive, and

FIG. 2 is a partial section through a structural element having a substrate.

### DETAILED DESCRIPTION OF THE DRAWINGS

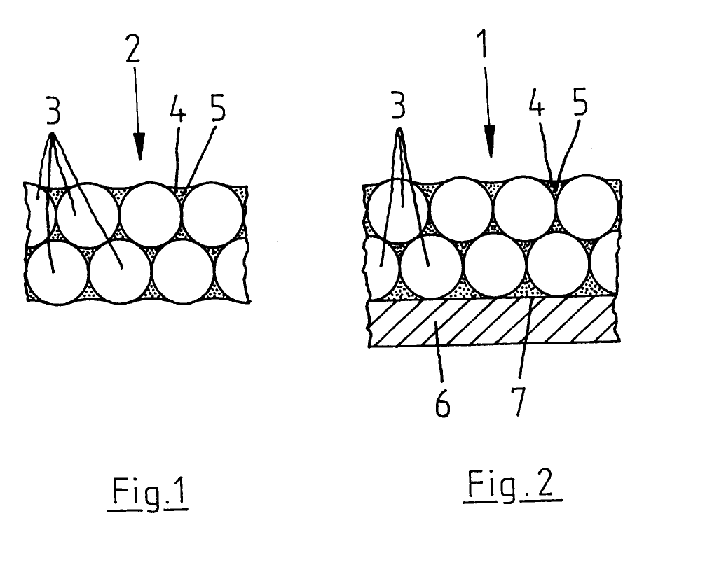

FIG. 1 shows the abutting hollow spheres 3 as well as the adhesive 4 that more or less fills in the empty spaces between the hollow spheres. A powdered additive material 5 may be mixed into the adhesive 4, which improves the properties of the adhesive, e.g., its shrinkage behavior. The depicted structural mass 2 is not supposed to be dried or cured and is adjusted to a fluid to paste-like consistency. It is possible to produce self-supporting semi-finished products from the structural mass 2 by drying and curing. However, the structural mass 2 is preferably applied to a substrate 6 or introduced into at least one cavity of a substrate.

FIG. 2 depicts such a structural element 1 with a substrate 6, on whose surface 7 a structural mass is applied and connected to the substrate 6 by drying and/or curing. Applying the structural mass to the substrate 6 is preferably accomplished by smoothing or painting. After curing, a mechanical after-treatment of the free structural surface can be carried out, e.g., by jiggering. The cured structural mass is especially suited as a rub coating or intake coating for gas turbine seals. The material for the hollow spheres 3 may be freely selected within wide limits, and the possibility also exists of mixing metallic or intermetallic hollow spheres 3 with ceramic and/or vitreous hollow spheres 3.

The not-yet dried and not-yet cured structural mass can be introduced into the cavities in a substrate, e.g., by pouring. This design variant then is used to provide hollow blades of gas turbines with an internal protective structure against sulfidation, oxidation, etc.

It is clear to the person skilled in the art that the application possibilities of the invention are not exhausted by far with the so-called examples. A multitude of other application possibilities are conceivable, in particular in the stator and rotor areas of gas turbines. Light-weight elements in the widest possible sense are mentioned here as the keyword. By using adhesion as the joining method, the material selection is no longer limited to materials that can be welded, sintered and soldered. As a result, in terms of materials, structural elements having new and optimized properties are possible. Because, in contrast to most metallurgical methods, the maximum temperatures during production do not need to be higher than the subsequent utilization temperatures, damage to materials from the manufacturing process is not to be anticipated.

1-15. (canceled)

16. A method for producing a structural element having a low density and high temperature resistance, comprising the steps of:
connecting a plurality of hollow spheres made of a high temperature resistant material together in a material fit;
forming adhesive bridges made of a high temperature resistant, inorganic adhesive between the hollow spheres; and
drying and curing a structural mass made of the hollow spheres and the adhesive at a temperature that is higher than an ambient temperature and is not higher than a subsequent utilization temperature of the structural element.

17. The method according to claim 16, wherein the hollow spheres are adhered to one another and to a substrate.

18. The method according to claim 16, wherein a silicate or a phosphate is the inorganic adhesive.

19. The method according to claim 16, wherein a powdered metallic, intermetallic, ceramic and/or glass-like additive material is added to the adhesive.

20. The method according to claim 17, wherein the hollow spheres and/or the substrate are made of a metallic, intermetallic, vitreous or glass-like and/or ceramic material.

21. The method according to claim 16, wherein the structural mass is adjusted to a flowable or paste-like consistency.

22. The method according to claim 17, wherein the structural mass is applied by casting, painting or smoothing to the substrate.

23. The method according to claim 16, wherein the step of drying and curing is performed in several stages with an increasing temperature that is maintained approximately constant during each stage, wherein a temperature of a first stage corresponds approximately to the ambient temperature and a temperature of a final stage corresponds approximately to the subsequent utilization temperature of the structural element.

24. The method according to claim 23, wherein the step of drying and curing is performed in four stages, wherein a temperature during a second stage is approximately 80° C., wherein a temperature during a third stage is approximately in a range of 400° C. to 500° C., and wherein a temperature during the final stage is approximately in a range of 700° C. to 1200° C.

25. The method according to claim 23, wherein a holding time of every stage is approximately 1 hour.

26. The method according to claim 17, wherein alloys based on iron (Fe), titanium (Ti), nickel (Ni) and/or cobalt (Co) or a compound based on titanium (Ti) and aluminum (Al) is/are used for the hollow spheres and/or the substrate and/or a material added to the adhesive.

27. The method according to claim 16, wherein the hollow spheres have a diameter of approximately 0.2 mm to approximately 2 mm.

28. The method according to claim 16, wherein the hollow spheres have a wall thickness of approximately 40 μm.

29. The method according to claim 17, wherein the substrate is a gas turbine part having cavities and wherein the structural mass is introduced into the cavities by casting.

30. The method according to claim 16, wherein the substrate is a gas turbine component having smooth and/or structured surfaces and wherein the structural mass is applied to the surfaces by painting and/or smoothing.
